(19) United States
(12) Patent Application Publication
(10) Pub. No.: US 2004/0252665 A1
(43) Pub. Date: Dec. 16, 2004

(54) Method for increasing wireless communication system capacity

(76) Inventors: Andrew C. Clark, Succasunna, NJ (US); Mark H. Kraml, Flanders, NJ (US); Gregg Nardozza, Glenwood, NJ (US)

Correspondence Address: CARLSON, GASKEY & OLDS, P.C., 400 WEST MAPLE ROAD, SUITE 350, BIRMINGHAM, MI, 48009, US

(21) Appl. No.: 10/459,634

(22) Filed: Jun. 11, 2003

(51) Int. Cl. H04B 7/216

(52) U.S. Cl. 370/335

(57) ABSTRACT

A method of increasing a number of possible users in a wireless communication system comprises directing steered beams to users within a sector of the system so that each user receives data via its own unique steered beam from a base station. The steered beams prevent more than one user from receiving data carried on the same beam. If the steered beams for at least two users are far enough apart so they do not interfere with each other, the base station assigns the two users the same code, such as the same Walsh code, for coding and decoding purposes to allow the base station to assign the same code to more than one user in a given sector.

### BACKGROUND OF THE INVENTION

1. Field of the Invention

The present invention is related to wireless communication systems.

2. Description of the Related Art

Wireless communication systems rely on data sharing arrangements to allow multiple users to share common resources. As shown in FIG. 1, the wireless system 100 has a base station 102 acting as a communications hub for each particular coverage area, or sector 104.

Mobile devices associated with users 106 within a given sector 104 share common resources. Base station 102 may employ a resource assignment algorithm ensure that the resources are fairly distributed among the users 106. As is known in the art, CDMA assigns multiple users 106 to transmit and receive data on the same frequency in a given sector 104. To distinguish among different users 106 in the sector 104, Walsh coding or other orthogonal coding schemes are used in the forward link (from the base station 102 to each user 106) to code the data from each individual user 106, distinguishing the data for each user. As shown in FIG. 1, the base station 102 transmits a broad beam 107 received by multiple users 106 in the sector 104, requiring (indicated as Code 1, Code 2, etc. in this example for purposes of illustration).

The capacity of currently-known wireless systems are limited by the number of available Walsh codes set by wireless standards. Although it is possible to increase the capacity of CDMA signal carriers, the number of available Walsh codes is still fixed. Thus, even though the system may have the ability to support an increased number of users, the number of available Walsh codes set by the standard prevents the system from taking advantage of the additional capacity.

There is a desire for a method that overcomes the limitations of a fixed number of available Walsh codes to take advantage of the increased user capacity in a wireless system provided by steered beams.

### SUMMARY OF THE INVENTION

The present invention is directed to a method of increasing a number of possible users in a wireless communication system. The method comprises directing steered beams to users within a sector of the system so that each user receives data via its own unique steered beam from a base station. The steered beams prevent more than one user from receiving data carried on the same beam.

If the steered beams for at least two users are far enough apart so they do not interfere with each other, the base station assigns the two users the same code, such as the same Walsh code, for coding and decoding purposes. Thus, the invention allows the base station to assign the same code to more than one user in a given sector, overcoming the limitations imposed by the fixed number of available codes set by wireless standards. As a result, the invention increases the capacity of a wireless system by making it possible to accommodate more users than previously-known systems relying on a one-to-one correspondence between the number of available codes and the number of users that a sector can accommodate.

### BRIEF DESCRIPTION OF THE DRAWINGS

FIG. 1 is a representative diagram illustrating one embodiment of a wireless system operating environment; and

FIG. 2 is a representative diagram illustrating a method according to one embodiment of the invention.

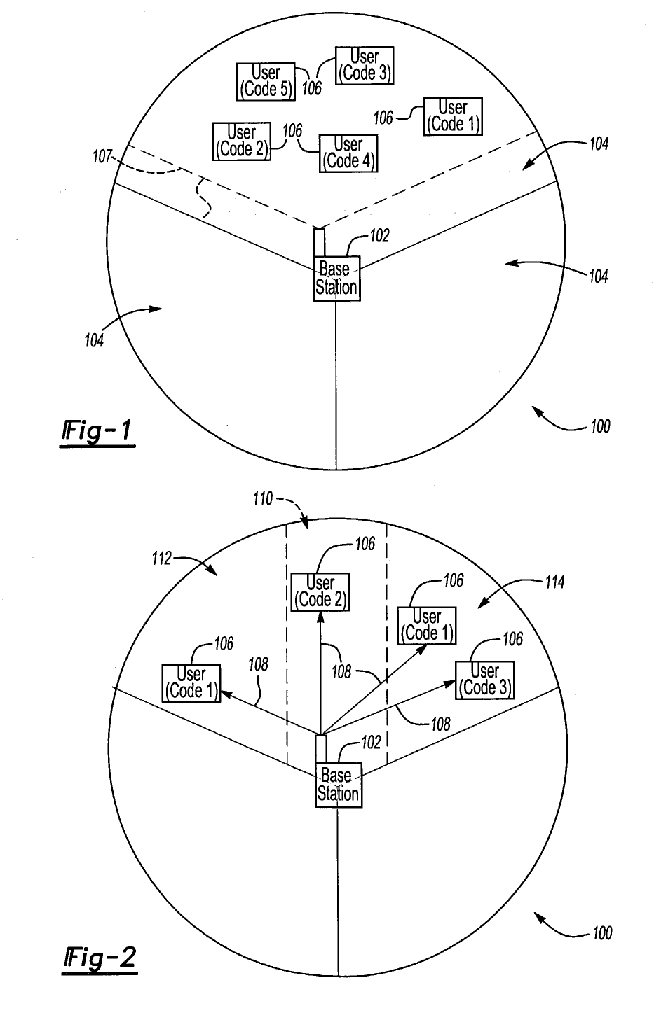

### DETAILED DESCRIPTION

The examples described below focus on a wireless system using a steered beam system to improve capacity; however, the inventive method can be incorporated in any system to increase the number of users that the system can support and to take advantage of increased system capacity.

As is known in the art, conventional antennas in a wireless system send signals over a broad beam, covering a large number of users 106 over a wide area. Steered beam systems use a more focused, narrow beam to reach an individual user 106 at any given time on a per user basis. Thus, instead of sending data via a broad beam that can be received by many or all of the users in the sector 104, the base station 102 in a steered beam system focuses a unique narrow beam on an individual user 106 when sending data corresponding to that user 106. In other words, the base station 102 forms and transmits beams on a per-user basis.

FIG. 2 is a representative diagram illustrating multiple users 106 in a sector 104. For clarity, the users 106 are shown in only one sector 104, but each sector 104 can contain any number of users 106. Each user 104 receives a focused narrow beam 108 from the base station 102 to receive data. As shown in FIG. 2, the sector 104 can be divided into two or more subsections. In this example, a center subsection 110 separates left and right subsections 112, 114, but the subsections can have any shape, size and configuration.

Because the users 106 in the left and right subsections 112, 114 are separated far enough from each other within the sector 104, the individual users 106 in different subsections 112, 114 can use the same Walsh code. In the illustrated example, one user 106 in the left subsection 112 has the same code (i.e., Code 1 in this example) as another user in the right subsection 114. In other words, focusing individual beams on specific users 106, rather than using a broad antenna beam, allows the base station 102 to assign the same Walsh code to users 106 in different subsections 112, 114 because the beams for the users 106 are far enough apart to not interfere with each other.

If there are two users 106 that are initially located in different subsections 112, 114 but are moving closer together, the users 106 may end up at a distance close enough to cause interference between their respective focused beams 108. Interference between two or more users having the same assigned Walsh code may cause one user 106 to accidentally receive and decode data meant for another user 106. To avoid this, a Walsh code handoff may be conducted for one of the users 106 to change its assigned Walsh code and avoid potential interference between two or more users 106 having the same Walsh code.

For illustrative purposes only, FIG. 2 illustrates a subsection 110 where none of the users 106 in that subsection 110 can use the same Walsh code as users 106 in the other subsections 112, 114 because the users 106 are too close together. Similarly, if a user 106 moves into a subsection having another user 106 using the same Walsh code, the Walsh code of one of the users 106 should be changed to avoid interference. The specific method of detecting user proximity and determining whether to change the Walsh code of one user can be conducted via any known process.

Thus, the invention enables codes, such as Walsh codes, to be reused within the same sector 104 provided that the users 106 are far enough apart (e.g., located in different sub-sections 112, 114) that the focused beams 108 to the respective users 106 do not interfere with each other. The invention allows an increased number of users 106 to occupy a given sector without any changes to any wireless standards. Instead, the invention can be implemented by combining the advantages of steered beam systems and reuse of Walsh codes to overcome the limitations on the number of Walsh codes set forth in the wireless standards. The invention can be used in any wireless application, including military applications that use radar or sonar to transmit data, as well as conventional consumer applications.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, this method, system and portions thereof and of the described method and system may be implemented in different locations, such as network elements, the wireless unit, the base station, a base station controller, a mobile switching center and/or radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments as fall within the true scope of the invention.

We claim:

1. A method of transmitting data in a wireless communication system, comprising:
transmitting data to a first user in a sector with a code; and
transmitting data to a second user in the sector with the code such that the first and the second user use the same code
wherein the data is transmitted to the first and second users at the same time.

2. The method of claim 1, wherein data is transmitted to the first user via a first steered beam and data is transmitted to the second user via a second steered beam.

3. The method of claim 1, further comprising:
changing the code associated with the second user to a second code if a distance between the first and second users falls below a predetermined amount.

4. The method of claim 1, wherein the code is a Walsh code.

5. A method of transmitting data in a wireless communication system, comprising:
transmitting data to a first user in a sector with a code via a first steered beam;
transmitting data to a second user in the sector with the code via a second steered beam such that the first user and the second user use the same code, wherein the data is transmitted to the first and second users at the same time; and
changing the code associated with the second user to a second code if a distance between the first and second users falls below a predetermined amount.

6. The method of claim 5, wherein the code and the second code are Walsh codes.
